(19) United States
(12) Patent Application Publication
(10) Pub. No.: US 2007/0287819 A1
(43) Pub. Date: Dec. 13, 2007

(54) Method for measuring concentration of propylene polymer slurry, and process for producing propylene polymer

(75) Inventors: Tomoaki Tanaka, Ichihara-shi (JP); Hajime Kobayashi, Chiba-shi (JP)

Correspondence Address: FOLEY AND LARDNER LLP;SUITE 500, 3000 K STREET NW, WASHINGTON, DC, 20007, US

(73) Assignee: Sumitomo Chemical Company, Limited

(21) Appl. No.: 11/808,062

(22) Filed: Jun. 6, 2007

(30) Foreign Application Priority Data
Jun. 13, 2006 (JP) 2006-163198

(51) Int. Cl. C08F 110/06

(52) U.S. Cl. 526/351; 526/348.6

(57) ABSTRACT

A method for measuring a concentration of a propylene polymer slurry contained in a polymerization reactor, in which liquid phase-filled polymerization of propylene or a combination of propylene with a comonomer is carried out, according to the defined formula, slurry concentration=0.1(Q₀−Q_{I})/(QₚP_{I}); and a process for producing a propylene polymer comprising the step of homopolymerizing propylene or copolymerizing propylene with a comonomer in a liquid phase-filled polymerization reactor while measuring a concentration of a propylene polymer slurry contained in said polymerization reactor according to the above formula.

### FIELD OF THE INVENTION

The present invention relates to a method for measuring a concentration of a propylene polymer slurry contained in a polymerization reactor during slurry polymerization whose inside is filled completely with a liquid phase; and a process for producing a propylene polymer while measuring said concentration. In the present invention, the above-mentioned “polymerization reactor whose inside is filled completely with a liquid phase” is referred to as “liquid phase-filled polymerization reactor”, and the above-mentioned “slurry polymerization” which is carried out in a liquid phase-filled polymerization reactor is referred to as “liquid phase-filled polymerization”.

### BACKGROUND OF THE INVENTION

There is known in the art a process for producing an olefin polymer comprising the step of polymerizing an olefin in a liquid phase-filled polymerization reactor. For example, (1) JP 11-12310A discloses a method for bulk polymerizing propylene in a liquid phase-filled polymerization reactor using a homogeneous catalyst, and (2) JP 2002-60402A discloses (2-1) a liquid phase-filled polymerization reactor, (2-2) a method for discharging a polymer-containing slurry from said reactor, and (2-3) a process for producing an olefin polymer using said discharge method.

When a polymerization condition is changed during liquid phase-filled polymerization of an olefin: for example, when a supply rate of an olefin is increased or decreased while maintaining constant polymerization temperature and pressure, in order to increase or decrease a production rate of an olefin polymer, said supply rate of an olefin and a supply rate of cooling water to remove polymerization heat must be changed under carefully controlling polymerization temperature and pressure such that they do not deviate overly from preset polymerization temperature and pressure, in order to continue a stable polymerization.

### SUMMARY OF THE INVENTION

A fundamental and important item, which should be monitored all during liquid phase-filled polymerization in order to continue stably liquid phase-filled polymerization, is a concentration of an olefin polymer slurry contained in a liquid phase-filled polymerization reactor. However, it is impossible to measure directly said concentration during liquid phase-filled polymerization, because liquid phase-filled polymerization of an olefin is carried out at high temperature and pressure. Also, there is not known in the art a method for measuring a concentration of an olefin polymer slurry contained in a polymerization reactor all during liquid phase-filled polymerization.

In view of the above-mentioned problems in the conventional art, the present invention has an object to provide (i) a method for measuring a concentration of a propylene polymer slurry contained in a liquid phase-filled polymerization reactor all during liquid phase-filled polymerization, and (ii) a process for producing stably a propylene polymer while measuring said concentration.

The present inventors have undertaken extensive studies on a process for producing stably a propylene polymer according to liquid phase-filled polymerization, and as a result, have found that a concentration of a propylene polymer slurry contained in a liquid phase-filled polymerization reactor has a relationship with (i) an amount of heat removed from said polymerization reactor, (ii) an amount of heat brought into said polymerization reactor, (iii) an amount of polymerization heat of propylene, and (iv) an amount of propylene supplied to said polymerization reactor, and that said relationship can be represented by a specific formula. The above-mentioned concentration of a propylene polymer slurry, which is hereinafter referred to as “slurry concentration”, is a ratio (% by weight) of an amount of a propylene polymer contained in a slurry to the total amount (100% by weight) of the slurry.

The present invention is a method for measuring a concentration of a propylene polymer slurry contained in a polymerization reactor, in which liquid phase-filled polymerization of propylene or a combination of propylene with a comonomer is carried out, according to the following formula (1):

slurry concentration=0.1(Q₀−Q_{I})/(QₚP_{I}) (1)

wherein Q₀ (kcal/hr) is an amount of heat per hour removed from the polymerization reactor; Q_{I} (kcal/hr) is an amount of heat per hour brought into the polymerization reactor; Qₚ (kcal/kg) is an amount of polymerization heat per kilogram of propylene; and P_{I} (ton/hr) is an amount of propylene per hour supplied to the polymerization reactor.

Also, the present invention is a process for producing a propylene polymer comprising the step of homopolymerizing propylene or copolymerizing propylene with a comonomer in a liquid phase-filled polymerization reactor while measuring a concentration of a propylene polymer slurry contained in said polymerization reactor according to the above-mentioned formula (1).

### DETAILED DESCRIPTION OF THE INVENTION

A liquid medium contained in the “liquid phase” of the above-mentioned “liquid phase-filled polymerization reactor” or “liquid phase-filled polymerization” consists essentially of a monomer itself to be polymerized. The liquid medium is particularly preferably propylene.

In the present invention, the above-mentioned slurry polymerization may be slurry polymerization known in the art. Therefore, polymerization requirements for said slurry polymerization such as a polymerization reactor and a polymerization condition may be those known in the art. In the present invention, polymerization temperature and pressure are set usually at 50 to 70° C. and 3 to 5 MPaG, respectively.

A polymerization reactor used in the present invention is not particularly limited in its type, and it may be a vessel type reactor known in the art, or a loop type reactor known therein. A liquid phase-filled polymerization reactor may be combined with other reactor whose inside is not filled completely with a liquid phase. An example thereof is a combination of a liquid phase-filled polymerization reactor with a gas-phase polymerization reactor connected to said liquid phase-filled polymerization reactor in series. Incidentally, there has been commercially and generally produced a propylene polymer using a combination of a liquid-phase polymerization reactor with a gas-phase polymerization reactor, which is similar to the above combination, along with development of a polymerization catalyst having a high polymerization activity such as 50,000 to 100,000 g-polymer/g-solid catalyst component.

A vessel type reactor or a loop type reactor, which can be used as a representative polymerization reactor in the present invention, usually has (i) a water-cooling jacket on its outside to remove heat from the reactor, (ii) a pump in its inside to circulate and agitate a polymerization reaction mixture in the reactor, and (iii) an external circulating apparatus (with a motor) equipped with an external cooler besides the above-mentioned water-cooling jacket, in order to cool the polymerization reaction mixture.

The “propylene polymer” in the present invention means (i) a propylene homopolymer, or (ii) a copolymer containing a large number of a propylene unit and a small number of a comonomer unit selected from the group consisting of an ethylene unit and an α-olefin unit having 4 to 8 carbon atoms. Said copolymer contains preferably 96 to 99% by weight of a propylene unit and 1 to 4% by weight of a comonomer unit, the total of both units being 100% by weight. Examples of the α-olefin are 1-butene, 1-hexene and 1-octene. Among them, preferred is ethylene or 1-butene. The propylene polymer is preferably a propylene homopolymer, a propylene-ethylene copolymer, a propylene-1-butene copolymer, or a propylene-ethylene-1-butene copolymer.

The above formula (1) has been resulted from the present inventors' extensive studies comprising the steps of (i) arranging many kinds of past data accumulated on a process for producing a propylene polymer according to liquid phase-filled polymerization, such as (a) data about a slurry concentration, which is not a slurry concentration measured according to the formula (1), but a slurry concentration calculated based on an actual production amount of a propylene polymer and polymerization conditions, (b) data about an amount of heat removed from a polymerization reactor, (c) data about an amount of heat brought into a polymerization reactor, (d) data about an amount of propylene supplied to a polymerization reactor, (e) data about polymerization temperature, (f) data about polymerization pressure, and (g) data about an amount of hydrogen gas as a molecular weight regulator supplied to a polymerization reactor; and (ii) investigating and discussing those arranged data from various points of view.

Q₀ (kcal/hr) in the formula (1), which is an amount of heat per hour removed from a polymerization reactor, is the total of (i) Q₀₁: an amount of heat removed by the above-mentioned water-cooling jacket, (ii) Q₀₂: an amount of heat required for heating a monomer supplied to a polymerization reactor up to a polymerization temperature, (iii) Q₀₃: an amount of heat discharged to the atmosphere, and (iv) Q₀₄: an amount of heat removed by the above-mentioned external cooler. There are known in the art various methods for calculating those amounts, Q₀₁ to Q₀₄.

Q_{I} (kcal/hr) in the formula (1), which is an amount of heat per hour brought into a polymerization reactor, consists mainly of (i) Q_{I1}: an amount of heat generated by a power of the above-mentioned pump, and (ii) Q_{I2}: an amount of heat generated by a circulation power of the above-mentioned external circulating apparatus.

Qₚ (kcal/kg) in the formula (1), which is an amount of polymerization heat per kg of propylene, is a fixed number of 510 kcal/kg. The reason why an amount of polymerization heat of a comonomer does not need taking into account from a viewpoint of accuracy of the formula (1), when producing a copolymer of propylene with a comonomer, is that said copolymer contains such a small number of a comonomer unit as mentioned above that an amount of polymerization heat thereof is negligible.

P_{I} (ton/hr) in the formula (1), which is an amount of propylene per hour supplied to a polymerization reactor, is the total amount of propylene supplied thereto. Therefore, when propylene is supplied to a polymerization reactor through two or more inlets, P_{I} is the total of respective amounts supplied through them. When producing a copolymer of propylene with a comonomer, it is not necessary to take account of an amount of the comonomer supplied to a polymerization reactor from a viewpoint of accuracy of the formula (1), because of the same reason as that mentioned above.

(Q₀−Q_{I}) in the formula (1) is an amount of heat generated in a polymerization reactor. Said amount can be obtained by a heat balance analysis of the polymerization reactor.

QₚP_{I} in the formula (1) is an amount of polymerization heat of propylene, provided that the total amount of propylene supplied to a polymerization reactor is polymerized. QₚP_{I} is a product of Qₚ (510 kcal/kg: amount of polymerization heat of propylene) and P_{I} (ton/hr: amount of propylene supplied to a polymerization reactor).

In order to accomplish the object of the present invention, the measurement of a concentration of a propylene polymer slurry according to the formula (1) is particularly preferably performed with a computer placed in a propylene polymer-producing factory to monitor said concentration all during liquid phase-filled polymerization.

The method for measuring a concentration of a propylene polymer slurry according to the present invention is preferably used in a case such as the following embodiments, and is particularly preferably used in the following case (1):

(1) case of increasing or decreasing an amount of a monomer supplied to a polymerization reactor during liquid phase-filled polymerization, in order to increase or decrease a production amount of a propylene polymer up to or down to a target production amount thereof;

(2) case of increasing or decreasing an amount of a cooling medium such as water supplied to a cooling jacket or an external cooler during liquid phase-filled polymerization, in order to lower or raise polymerization temperature down to or up to target polymerization temperature; and

(3) case of increasing or decreasing an amount of a molecular weight regulator such as a hydrogen gas supplied to a polymerization reactor during liquid phase-filled polymerization, in order to raise or lower a melt index of a propylene polymer up to or down to a target melt index thereof.

In the above case (1), an amount of a monomer supplied to a polymerization reactor is increased or decreased while monitoring a concentration of a propylene polymer slurry measured according to the formula (1) such that a concentration thereof measured according to the formula (1) comes stably to a concentration of a propylene polymer slurry calculated separately based on a target production amount of a propylene polymer.

In the above case (2) or (3), a production amount of a propylene polymer is also changed in spite of no change in an amount of a monomer supplied to a polymerization reactor, because polymerization reactivity of the monomer is changed. Therefore, it is important to monitor a concentration of a propylene polymer slurry measured according to the formula (1) in order to lower or raise stably polymerization temperature in the case (2), or in order to increase or decrease stably an amount of a molecular weight regulator in the case (3), under the change of polymerization reactivity of the monomer.

In the process for producing a propylene polymer according to the present invention, a concentration of a propylene polymer slurry, namely, an amount of a propylene polymer contained in a polymerization reaction mixture slurry is preferably 5 to 50% by weight, provided that the total amount of the polymerization reaction mixture slurry is 100% by weight. Therefore, said process for producing a propylene polymer is carried out under a condition that a concentration of a propylene polymer slurry measured according to the formula (1) is preferably within the range of 5 to 50% by weight. When said concentration is lower than 5% by weight, a needlessly large amount of propylene is supplied to a gas-phase polymerization reactor connected to a liquid phase-filled polymerization reactor in series. When said concentration is higher than 50% by weight, flowability of a propylene polymer slurry is deteriorated in a liquid phase-filled polymerization reactor, which increases the load on a pump of an external circulating apparatus, and as a result, a polymerization reaction becomes unstable.

There is no limitation in a polymerization catalyst used for producing a propylene polymer in the present invention. The polymerization catalyst may be known in the art. An example of the polymerization catalyst known in the art is that formed by combining (i) a solid catalyst component containing a titanium atom, a magnesium atom and a halogen atom as an essential component, (ii) an organoaluminum compound such as triethylaluminum, and (iii) an external electron donor such as cyclohexylethyldimethoxytitanium, with one another. Examples of the solid catalyst component are those disclosed in a patent document such as U.S. Pat. No. 4,223,117A, GB1498862A, U.S. Pat. No. 4,107,413A, GB1492618A, U.S. Pat. No. 4,412,049A, GB2033910A, GB2097413A, EP575118B, U.S. Pat. No. 4,302,565A, U.S. Pat. No. 5,068,489A, U.S. Pat. No. 4,490,475A, U.S. Pat. No. 6,521,560B, US2001/21687A, and US2003/195108A.

According to the present invention, there is provided (i) a method for measuring a concentration of a propylene polymer slurry contained in a polymerization reactor during a liquid phase-filled polymerization, and (ii) a process for producing stably a propylene polymer while measuring said concentration.

### EXAMPLE

The present invention is explained in more detail with reference to the following Examples, which do not limit the scope of the present invention.

### Example 1

There was used a loop reactor (30 L inner volume) equipped with (i) a monomer supply line, (ii) a polymerization catalyst supply line, and (iii) a pump for circulating and agitating a polymerization reaction mixture slurry in said reactor, in its lower part, (iv) a water-cooling jacket having a cooling water supply line and a cooling water discharge line for removing heat from said reactor, on its outside, and (v) a slurry transfer line for transferring said polymerization reaction mixture slurry to the next step, in its upper part, said loop reactor being similar to that disclosed in JP 2003-301004A.

There was continuously carried out liquid phase-filled polymerization of propylene at 70° C. (preset temperature) under 4.5 MPaG (preset pressure) by continuously supplying (i) propylene through said monomer supply line at a supply rate (P_{I}) of 0.044 ton/hour, (ii) a separately prepared solid catalyst component containing a titanium atom, a magnesium atom and a chlorine atom as an essential component through said polymerization catalyst supply line at a supply rate of 0.65 g/hour, (iii) triethylaluminum through said polymerization catalyst supply line at a supply rate of 4.57 g/hour, and (iv) cyclohexylethyldimethoxytitanium (external electron donor) through said polymerization catalyst supply line at a supply rate of 0.81 g/hour, thereby producing a propylene homopolymer. Under those polymerization conditions, the concentration of the propylene homopolymer slurry measured according to the formula (1) was about 20% by weight. The polymerization step up to this point is referred to as the former step for convenience of the following Example 2.

In order to increase a production rate of the propylene homopolymer up to a target production rate thereof, the propylene supply rate (P_{I}) of 0.044 ton/hour was increased up to 0.051 ton/hour (target rate), while monitoring the concentration of the propylene homopolymer slurry measured according to the formula (1) such that so-measured concentration was increased up to about 35% by weight (target concentration) from about 20% by weight, thereby continuing said liquid phase-filled polymerization. Said increase of propylene supply rate (P_{I}) up to 0.051 ton/hour (target rate) could be carried out without a drastic change in the polymerization temperature and pressure, the polymerization temperature being within the range of 69.4 to 70.7° C. (preset temperature: 70° C.), and the polymerization pressure being within the range of 4.42 to 4.47 MPaG (preset pressure: 4.5 MPaG). There was not also observed a drastic rise in a current value of the pump for circulating and agitating the polymerization reaction mixture slurry. In order to maintain the polymerization temperature at 70° C. (preset temperature), the amount of cooling water was increased automatically, because not only the production rate of the propylene homopolymer was increased by the above-mentioned increase of the propylene supply rate (P_{I}), but also an amount of heat (Q₀) removed from the polymerization reactor was increased thereby. The amount of heat (Q_{I}) brought into the polymerization reactor was also changed by the increase of P_{I}. Incidentally, the above-mentioned cooling water was maintained at constant temperature by external facilities.

### Example 2

A propylene homopolymer was produced according to the similar step to the former step in Example 1, by carrying out liquid phase-filled polymerization of propylene at 70° C. (preset temperature) under 4.5 MPaG (preset pressure) at a propylene supply rate (P_{I}) of 0.059 ton/hour in a concentration of a propylene homopolymer slurry of about 30% by weight measured according to the formula (1).

In order to decrease a production rate of the propylene homopolymer, the propylene supply rate (P_{I}) of 0.059 ton/hour was decreased down to 0.043 ton/hour (target rate), while monitoring the concentration of the propylene homopolymer slurry measured according to the formula (1) such that so-measured concentration was decreased down to about 15% by weight (target concentration) from about 30% by weight, thereby continuing said liquid phase-filled polymerization. Said decrease of propylene supply rate (P_{I}) down to up to 0.043 ton/hour (target rate) could be carried out without a drastic change in the polymerization temperature and pressure, the polymerization temperature being within the range of 69.2 to 71.0° C. (preset temperature: 70° C.), and the polymerization pressure being within the range of 4.41 to 4.49 MPaG (preset pressure: 4.5 MPaG). There was not also observed a drastic change in a current value of the pump for circulating and agitating the slurry polymerization reaction mixture. In order to maintain the polymerization temperature at 70° C. (preset temperature), the amount of cooling water was decreased automatically, because not only the production rate of the propylene homopolymer was decreased by the above-mentioned decrease of the propylene supply rate (P_{I}), but also an amount of heat (Q₀) removed from the polymerization reactor was decreased thereby. The amount of heat (Q_{I}) brought into the polymerization reactor was also changed by the decrease of P_{I}. Incidentally, the above-mentioned cooling water was maintained at constant temperature by external facilities.

1. A method for measuring a concentration of a propylene polymer slurry contained in a polymerization reactor, in which liquid phase-filled polymerization of propylene or a combination of propylene with a comonomer is carried out, according to the following formula (1):
slurry concentration=0.1(Q₀−Q_{I})/(QₚP_{I}) (1)
wherein Q₀ (kcal/hr) is an amount of heat per hour removed from the polymerization reactor; Q_{I} (kcal/hr) is an amount of heat per hour brought into the polymerization reactor; Qₚ (kcal/kg) is an amount of polymerization heat per kilogram of propylene; and P_{I} (ton/hr) is an amount of propylene per hour supplied to the polymerization reactor.

2. The method according to claim 1, wherein the propylene polymer contains 96 to 100% by weight of a propylene unit and 0 to 4% by weight of a comonomer unit selected from the group consisting of an ethylene unit and an α-olefin unit having 4 to 8 carbon atoms, the total of the propylene unit and the comonomer unit being 100% by weight.

3. The method according to claim 1, wherein the propylene polymer is a propylene homopolymer, a propylene-ethylene copolymer, a propylene-1-butene copolymer, or a propylene-ethylene-1-butene copolymer.

4. The method according to claim 1, wherein the comonomer is ethylene, 1-butene or a combination of ethylene with 1-butene.

5. A process for producing a propylene polymer comprising the step of homopolymerizing propylene or copolymerizing propylene with a comonomer in a liquid phase-filled polymerization reactor while measuring a concentration of a propylene polymer slurry contained in said polymerization reactor according to the following formula (1):
slurry concentration=0.1(Q₀−Q_{I})/(QₚP_{I}) (1)
wherein Q₀ (kcal/hr) is an amount of heat per hour removed from the polymerization reactor; Q_{I} (kcal/hr) is an amount of heat per hour brought into the polymerization reactor; Qₚ (kcal/kg) is an amount of polymerization heat per kilogram of propylene; and P_{I} (ton/hr) is an amount of propylene per hour supplied to the polymerization reactor.

6. The process for producing a propylene polymer according to claim 5, wherein the concentration of a propylene polymer slurry is 5 to 50% by weight.

7. The process for producing a propylene polymer according to claim 5, wherein the propylene polymer contains 96 to 100% by weight of a propylene unit and 0 to 4% by weight of a comonomer unit selected from the group consisting of an ethylene unit and an α-olefin unit having 4 to 8 carbon atoms, the total of the propylene unit and the comonomer unit being 100% by weight.

8. The process for producing a propylene polymer according to claim 5, wherein the propylene polymer is a propylene homopolymer, a propylene-ethylene copolymer, a propylene-1-butene copolymer, or a propylene-ethylene-1-butene copolymer.

9. The process for producing a propylene polymer according to claim 5, wherein the comonomer is ethylene, 1-butene or a combination of ethylene with 1-butene.
